(19) United States
(12) Patent Application Publication
(10) Pub. No.: US 2022/0030756 A1
(43) Pub. Date: Feb. 3, 2022

(54) RETROFITTING KIT TO BE MOUNTED ON AN AGRICULTURAL IMPLEMENT

(71) Applicant: Lemken Gmbh & Co KG, Alpen (DE)

(72) Inventor: Hendrik Vennemann, Olfen (DE)

(21) Appl. No.: 17/284,423

(22) PCT Filed: Oct. 7, 2019
(86) PCT No.: PCT/DE2019/100866

§ 371 Date: Apr. 9, 2021

(30) Foreign Application Priority Data
Oct. 8, 2018 (DE) 10 2018 124 705.2

(51) Int. Cl. A01B 63/12; G05B 19/042

(52) U.S. Cl. CPC A01B 63/12; G05B 2219/45017; G05B 19/042

(57) ABSTRACT

The present invention relates to a retrofitting kit (3) having electrical and/or electronic components to be mounted on an agricultural implement (4), which can be mounted on/attached to a tractor (2) and which is operated in combination therewith.

The present invention relates to a retrofitting kit having electrical and/or electronic components to be mounted on an agricultural implement, which can be mounted on/attached to a tractor and which is operated in combination therewith.

It is known from document EP 1 666 996 B1 to use tractors with working implements mounted thereon, but whereby the working implements are in each case already equipped with a separate job computer. A retrofitting of available implements, which are mounted on or attached to a tractor, with sensors, actuators, and a job computer, is not disclosed there. The fact that a control device firmly belongs to an implement used in agriculture is prior art. The job computer available on the working implement can be connected to the tractor via an ISOBUS interface. In the case of implements without job computer, the electronics installed on the tractor assumes the optimization of the use of the implement. As a rule, however, the tractor thereby generally does not have any software and hardware, which is designed specifically for an optimized operation of the respective mounted or attached implements.

Many implements, which are front-, side-, or rear-mounted on the tractor and which are provided as implements, which are carried or which are provided with a separate ground support and which do not have a or only a minimal electronic equipment, are still currently used in agricultural engineering. However, with the use of expert systems, the need to make the use of implements that are equipped in an electronically simple manner more efficient and to make the tractor driver's work easier, if possible, simultaneously rises as well. Due to the fact, however, that the various implements are used on a regular basis only during certain limited time periods of a few weeks a year, the profitability calculation for these implements does not support any high investments in the electronics.

It would nonetheless be desirable, if implements, which today do not yet have any or only little electronics, could be equipped in the future with an electronics, which supports the function of the implements and which relieves the tractor driver. This also applies in particular for the large number of existing machines on the market, which could be operated more efficiently with the use of more electronics. However, the hardware and software-related development and production of an implement-specific onboard electronics for agricultural implements is associated with high costs, so that this often does not happen to this day. An upgrading of agricultural implements with a function-supporting electronics thus needs to take place as cost-efficiently as possible.

It is the object of the present invention to create a mounting option for electronic components on agricultural implements, which provides for an electronically controlled functional optimization of these implements, including an option for the cost-efficient retrofitting of control electronics, with low investment costs.

The object is solved by means of a retrofitting kit, which has implement-specific components for the permanent mounting on the agricultural implement, and a first interface for the electronic connection of the implement-specific components to a portable computer unit, which can be used as required.

The option of being able to also retroactively mount electronic components on agricultural working implements in a cost-efficient manner follows from the idea of creating a retrofitting kit, which has machine-specific components, which permanently remain on the respective working implement, as well as an interface, to which a portable computer unit can be connected, as required. The implement-specific components of the retrofitting kit make it possible to equip and retrofit simpler mechanical implements with an intelligent and networked electronics, without thereby making the agricultural implements overly expensive.

This is based on the knowledge that the expensive electronic components, which includes the portable computer unit as hardware, do not have to be permanently and simultaneously kept ready on all agricultural implements. On the contrary, it is possible to use the portable computer unit, which can be used on various implements, only when currently using a respective agricultural implement. If a tractor driver starts to use a first agricultural implement, he attaches the portable computer unit to this implement, and starts working with it. When the current use of the first agricultural has been completed, the tractor driver can remove the portable computer unit from this implement and can mount it again on a second agricultural implement, which is to be used as next implement. This can be repeated as often as necessary. The implement-specific components remain on the respective agricultural implement, and the portable computer unit moves. The portable computer unit of the retrofitting kit is thus a mobile computer unit, which can be interchanged between various agricultural implements and which can be connected via a defined first interface to the respective agricultural implement via the implement-specific components installed there, and which is ready for operation quickly and easily. The portable computer unit can always be mounted and removed again very easily via the first interface for the electronic connection of the implement-specific components to a portable computer unit, which can be used as required. The mobile electronic hardware and software of the portable computer unit covers a plurality of applications.

The portable computer unit generates costs once because it includes many building blocks, which are required for the electronic function help of various types of agricultural implements. In addition to the pure computer and electronic storages for storing software and/or data, additional modules may be added, such as, for example, a power store, a radio module for the data exchange with external implements, one or several bus interfaces, for example for the communication with the job computer on the tractor, and a navigation module for determining the current location in the course of a cultivation. Various evaluation units for various sensor systems can also be present on the portable computer unit. Due to the fact, however, that the portable computer unit is acquired only once for various implements, the acquisition pays off for the user.

The portable computer unit preferably has various software packages, which are tailored to the use during operation of the respective agricultural implements, and which are in each case activated for the use of a currently used implement. Depending on the size of the software package, different levels of functionality are possible in the combination of the portable computer unit with the implement-specific components. Ranging from simple control and monitoring functions, to remotely controllable settings and adjustment of the working components and of the working processes, all the way to automated controls and regulations, including the automated optimization of the implement settings, all options are available here, which can be implemented by means of the retrofitting kit. Diagnostic systems can be integrated in the portable computer unit if the components required for doing so are installed on the machine side. Data can be exchanged with external manufacturer-bound or manufacturing-bound expert systems via the radio module.

The portable computer unit is adaptive due to the installation of new additional and updated software, and can be expanded to further available and new agricultural implements, as required.

The first interface is preferably standardized for all agricultural implements, which are to be equipped and operated with the retrofitting kit. The standardization refers in particular to the number and spatial arrangement and formation of the electrical and electronic connections, of the power supply, of the communication, and of the data exchange between the electronic components, which are connected to one another via the first interface, but also of the installed computing power, clock rates, software packages, and the like, for the connected modules. The standardization of the interface preferably ensures that the portable computer unit is ready for operation immediately after the connection thereof to the first interface without further additional manual connecting, setting, adapting, and test work.

For clarification purposes, it is pointed out that the retrofitting kit cannot only be installed in order to retrofit used implements, which are already on the market, but also as option or as standard equipment in new machines. The advantage is that the operator of machinery can use the portable computer unit in his new agricultural implements as well as in already available implements in this way. Between new and already available implements, there will then be no system discontinuity in the used electronics, which would prevent a continuous use of the portable computer unit in the machinery. On the contrary, the electronics package, which is used in new implements, can also be used in older implements in this way.

According to a design of the invention, the first interface has one or several electrical and/or electronic plug connections, which connect the portable computer unit in the operating position to at least one of the implement-specific components, and an additional mechanical connection for fixing the position of the portable computer unit in the operating position additionally exists between the implement-specific components and the portable computer unit in the operating position. When inserting the portable computer unit in the interface, the electrical plug connections are mandatorily operatively and spatially properly connected to one another via the interface, so that not every plug connection has to be established individually. The portable computer unit is fixed in the operating position via the mechanical connection, so that functional disturbances do not occur, in particular also not in the electrical connections, in spite of vibrations and impacts during operation of the agricultural implement.

According to a design of the invention, the implement-specific components and/or the portable computer unit have a second interface to the control electronics of the tractor and/or to an operating terminal arranged in the tractor cab. Via the second interface, the agricultural implement can exchange data with the electronics of the tractor, for example via a CAN bus, ISOBUS, or other interface for a data exchange between electronic systems, or can display information on the operating terminal in the tractor cab. Warning and error messages, optimization proposals for the operation of the agricultural implement, control displays, statistical or business management-related data or other data, which arrives in the portable computer unit from the sensors and/or the actuators, can be made available to the tractor driver in this way. The portable computer unit thus does not require a separate operating terminal, but can build on the available hardware of the tractor. The electronics as a whole thus remains cost-efficient. Via the second interface, a communication unit located in the tractor can also be used to exchange data with external computers. This is advantageous in particular when the portable computer unit itself does not have a communication module, which provides for a wireless data exchange with external computers.

According to a design of the invention, the first and/or second interface are formed as data bus connection, via which a data exchange with other electronic components connected to the data bus can take place. The communication via a data bus is advantageous, because the communication with various connected systems can be organized well via said data bus. Every node can thereby read out data from the data bus, which said node requires for its own function, and can even send data into the data bus, which could be useful to other nodes. The possible nodes in the respective implement-specific components of the agricultural implement can be organized, addressed, and coordinated in a hierarchy via the standardization of the first and/or second interface. The portable computer unit can be optimally connected to the further electronic components of an agricultural implement via the data bus, because only a single connection has to be established, and the same applies for the electronic connection to the tractor. Various bus systems, such as, for example, the CAN bus, but also other bus systems, such as, for example, the agriBus, FlexRay, or the like, are available for the use in agricultural implements.

According to a design of the invention, the implement-specific components of the retrofitting kit include sensors for determining process-relevant data and technical transmission means, by means of which the data determined by the sensors can be transmitted to the portable computer unit. The sensors for determining process-relevant data can be optical sensors, acoustic sensors, sensors for measuring physical properties, such as the implement load or utilization, or sensors for monitoring and documenting work processes. The sensors installed in an agricultural implement can be selected in many different ways, depending on what the sensors have to monitor. For instance, the quality of a soil cultivation performed by means of the agricultural implement can be evaluated by means of cameras with image evaluation and/or ultrasound, and the impacts of changes of process parameters, such as setting angle and working depth of working tools can be evaluated and controlled and/or displayed by means of such sensors. The soil moisture, mineral contents, quality parameters of the respective available agriculturally grown or harvested fruit or the like can also be detected by means of corresponding sensors. In addition, the sensors have to be placed at completely different locations of an implement and in different numbers, depending on arrangement and width of the working elements of an implement, in order to function optimally. This is why it is expedient to consider the sensors as an implement-specific component, which remains at the agricultural implement.

The technical transmission means can be a wiring, which usually has to be embodied in an implement-specific manner. The wiring provides for a reliable and interference-free data transmission between the available nodes, and thus also offers functional advantages. The installation of the wiring in an implement is comparatively complex and for this reason, it is also advantageous to leave the wiring, which likewise remains permanently at the implement, in an agricultural implement. However, other transmission means, such as, for example, components of a radio transmission of sensor values, infrared transmission means, or laser flashes, which are fed into optical fibers and optical cables for data transmission purposes, are possible as technical transmission means.

According to a design of the invention, the implement-specific components include an implement-specific wire harness. A wire harness, which is prefabricated for a certain agricultural implement, can be installed and connected more easily in an implement than a collection of colored wires, which may first have to be cut off with the appropriate length and have to be installed in the implement. By means of a wire harness and the functional tests, which are possible therewith prior to the installation in an agricultural implement, the errors, which are possible in the case of the setup and installation thereof, are reduced significantly.

According to a design of the invention, the implement-specific components include an actuator, which can be controlled by the portable computer unit. Hydraulic and pneumatic cylinders, hydraulic and pneumatic valves, electric motors, oil motors, and the like are possible as actuator. These actuator components are controlled by the portable computer unit, in order to change settings at the agricultural implement, to change work processes, and to adjust working tools.

According to a design of the invention, the implement-specific components include electronic slave modules, which can be operated in functional dependence on the portable computer unit. Functions, which are not required in other agricultural implements and which should thus expediently only be implemented in an implement-specific manner, can be displayed in the slave modules, or they are functional modules, which can only be obtained as a unit as vendor part and which are thus also operated as an implement-specific kit, which is operated in a functional dependency with the portable computer unit.

According to a design of the invention, the first interface for the electronic connection of the implement-specific components to the exchangeable portable computer unit has a connection for the electric voltage supply. If the portable computer unit is supplied with an operating voltage via the first interface, the need for another power supply is eliminated. The power supply also does not need to be established first by means of separate wires and separate connections in a complex manner. It is sufficient to connect the portable computer unit to the first interface, and to thus simultaneously establish and secure the power supply.

According to a design of the invention, the portable computer unit has a communication module. The portable computer unit can in particular exchange data with proprietary or non-proprietary websites via a communication module. In particular a module, which can also communicate across long distances in a mobile radio network, is possible as communication module. In particular the Internet, via which a data exchange is easily possible, can be reached via the mobile radio network. Operating data, implement settings, error states, load profiles, and the like can be transmitted from the agricultural implement, and suggestions for implement settings, error states, repair paths, load profiles, and the like can be downloaded in data form from the websites to the portable computer unit, in order to improve the operation of the agricultural implement. Software updates can also be performed or additional software packages can be downloaded to the portable computer unit. The communication module provides for the direct or indirect data exchange with the own farm or business computer, the agricultural machinery dealer, the crop consultant, external service providers, equipment manufacturers, such as fertilizer or seed manufacturers, the contractor, or the farmer, agencies, platforms for the data exchange, or buyers of the agriculturally produced product. All of this can take place in an implement-specific manner and can be stored for the respective implement. In the case of a communication module, which is installed on the portable computer unit, a single SIM card, which is installed therein and which comprises a corresponding network provider contract, is sufficient in order to be able to operate all agricultural implements in a networked manner when operating with the portable computer unit.

According to a design of the invention, the portable computer unit has a positioning module. Current cultivation of agricultural areas can be georeferenced via the localization. The exact localization of the current position also makes it possible to realize precision farming processes during the data generation by means of the agricultural implement and when completing work processes according to a prior partial area-specific planning.

According to a design of the invention, the portable computer unit has a wirelessly communicating module, such as, for example, a WLAN module, an IR module, an NFC module, or comparable technologies, which also provide for a data exchange over shorter ranges. Data can be exchanged with smart devices, which are within range, via a wirelessly communicating module. If, for example, an operating application software for the currently used agricultural implement is uploaded on a smartphone of the tractor driver, operating data of the agricultural implement can be displayed on the smartphone via the wireless connection, and the tractor driver can also transmit control commands or other operational specifications to the portable computer unit via the wireless connection. The wireless connection is generally also suitable to indirectly realize the functions described above for the communication module via the smart device implement if the latter is equipped accordingly.

According to a design of the invention, the portable computer unit has one or several connections to a data bus network. The data bus connections can be used to connect the portable computer unit to the data bus of the tractor, such as, for example, a CAN bus network, but also to operate a separate bus network, which exists for the respective agricultural implement, independently of the tractor bus network, or to connect I/O modules.

According to a design of the invention, the portable computer unit has a separate rechargeable storage for electrical energy. So that the portable computer unit can be operated independently of the power supply of the agricultural implement or the tractor, it is advantageous to equip the portable computer unit with a separate power supply. A separate power supply also provides for an anti-theft protection with or without geofencing functions.

According to a design of the invention, the portable computer unit has a module for the communication with the tractor. Tractor-specific functions, such as, for example, the speed of the power take-off shaft, hydraulic power, driving speed, lift height of the 3-point hydraulic system, and the like can be influenced or controlled completely according to the implement-specific requirements of the currently used agricultural implement via the communication module with the tractor.

According to a design of the invention, the input of operating commands to the portable computer unit and/or the output of information from the portable computer unit to an operator takes place via an app software installed on a separate mobile device, and a wireless communication connection existing between the portable computer unit and the separate mobile device takes place on the separate mobile device. With the integration of smart devices in the operation, control and monitoring of the agricultural implement, separate display screens in the portable computer unit can be forgone, which makes the latter more cost-efficient and simplifies the operation for the tractor driver.

According to a design of the invention, the input of operating commands to the portable computer unit and/or the output of information from the portable computer unit to an operator takes place via the second interface to the control electronics of the tractor and/or to an operating terminal arranged in the tractor cab. With the integration of the operator terminal of the tractor in the operation of the agricultural implement, the tractor driver can concentrate on the operating terminal of the tractor. The installation effort remains low, because the portable computer unit preferably controls the operating terminal of the tractor directly via the communication interface to the tractor.

According to a design of the invention, the first interface for the electronic connection of the implement-specific components to an exchangeable portable computer unit has an identification device, by means of which the portable computer unit recognizes the respective agricultural implement when being connected to the first interface. It is advantageous when the portable computer unit recognizes directly and automatically during the installation, which agricultural implement is to be operated with it. The portable computer unit can then start the software required for the control automatically or in a user-guided manner, request authorizations and presettings, establish connections, request updates, load and match job data, start the bus network or networks, activate operator displays, and the like. As soon as the portable computer unit has recognized the agricultural implement, which is to now be controlled by it, it can automatically configure accordingly in such a way that the agricultural implement is ready for use. The portable computer unit can likewise output error messages if the software required to control this agricultural implement is not loaded or if other error states are determined. The operation is facilitated significantly by means of the functions, which run in an automated manner. The change of the portable computer unit is thus also uncomplicated and is thus accepted by the users without reservation.

According to a design of the invention, the portable computer unit has a control program, which starts a control software, which is stored in the portable computer unit via the implement recognition and/or which is available remotely via a data connection, in order to control the recognized agricultural implement. The above statements apply analogously for this feature.

According to a design of the invention, the portable computer unit stores data collected during the operation of the agricultural implement on the portable computer unit and/or transmits the collected data via a data connection to a remote computer, depending on the technical equipment and setting. The data storage and management is becoming increasingly important for the users of agricultural machines. A function, which makes it possible to collect data, which is also collected in the first place, for towed or mounted agricultural implements, and to determine where this data is stored, facilitates the use of the agricultural implement for the user. The selected settings can be stored in an implement-specific manner and can be changed as needed.

According to a design of the invention, the portable computer unit has a software, which guides the user through an operating process in a dialog system, wherein the software, in dialog with the operator, transmits relevant control commands output by the operator for the operation of the agricultural implement to the control electronics of the tractor. A dialog system also enables an inexperienced operator to give the correct control commands for the best possible setting of the agricultural implement, which is equipped with the portable computer unit. The dialog system can be organized in the manner of a decision tree, in which various dependencies on partial decisions are displayed in a meaningful decision-making process. In particular when a decision-making aid, which includes expert knowledge, for machine settings is available for an agricultural implement, which the operator uses less often, a dialog system can keep an inexperienced operator from making wrong or suboptimal decisions, because dependencies, effects, and side effects of the decisions to be made can be make clear to him by means of additional information as part of the dialog. Various dialogs for many agricultural implements and operating situations can be stored on a portable computer unit, or it is possible to download the operating dialogs from a remote server for the concrete application situation, and to activate it, if necessary.

According to a design of the invention, the portable computer unit has a software, which can be operated in an automatic mode, wherein in the automatic mode, the software transmits control commands, which are relevant for the operation of the agricultural implement, to the control electronics of the tractor. It goes without saying that the computer unit can also simultaneously or alternatively be operated in the dialog mode, wherein the system then offers one or several input options to the user, awaits input commands, and reacts accordingly to one or several manually input operating commands. In the dialog mode, an operator can also request individual pieces of information, the computer unit can provide and display information permanently or selectively in a program-controlled manner, and, upon an input, the computer unit can show a new operator display, in which new operating commands can be input, or process sequences can be tracked. It goes without saying that an automatic mode offers more ease of use, because the operator does not have to continuously make individual operator inputs. For example, the forward driving speed of the tractor, the speed of the power take-off shaft, the capacity of the hydraulic pump, or the like can thus be influenced, for example, via this automatic function. An automated digging and lowering function can be realized, for example at the headland, in the case of imminent overloading of components or partial area-specific variations of the working depth, for example during soil cultivation, the fertilization, or the seed placement. Expert system-supported regulating parameters can also form the basis for control commands, which are transmitted to the control electronics of the tractor, for example if the sensors and the evaluation algorithms of the expert system recognize the work quality attained with the current settings as not being optimal during the soil cultivation, fertilization, or seed placement, and if adaptations and settings are required.

According to a design of the invention, the portable computer unit has a software, which can be operated in an automatic mode, wherein in the automatic mode, the software receives control commands, which are relevant for the operation of the agricultural implement, from the control electronics of the tractor and/or of the operating terminal, and transfers said control commands to the connected implement-specific components for the execution thereof. Depending on the operating state and operated agricultural implement, it is possible that the control electronics of the tractor or of the tractor drivers has to or should intervene in the control and regulation of the agricultural implement for functional or safety reasons. It is advantageous in such cases when the portable computer unit makes this possible in an automatic mode. The cases, in which this is possible, can be defined exactly in the software of the portable computer unit for the respective agricultural implement.

According to a design of the invention, the retrofitting kit also permits an operation of the agricultural implement without a portable computer unit, which is in the operating position. It is important that the respective agricultural implement is also ready for operation, should the portable computer unit ever not be available. The implement-specific components installed on the agricultural implement are then in an inactive status, in which they do not intervene in the basic functions of the agricultural implement. If actuators are available, which can be controlled by the portable computer unit, the setting and control thereof takes place in the inactive status of the retrofitting kit in the usual way, manually by the operator directly or via operating buttons from the tractor cab, so that the current conventional usability of the agricultural implement is not disturbed by the installation of the retrofitting kit. They can also remain in an inactive position, until a portable computer unit is connected again. When the portable computer unit is removed from an agricultural implement, the implement-specific components preferably switch automatically into the inactive status, in which they do not interfere with the conventional operation of the agricultural implement.

According to a design of the invention, the portable computer unit is designed to exchange data with another external computer, which is wirelessly connected to the portable computer unit, via a communication module, wherein the data is location and/or operating data of the agricultural implement and/or data for controlling and regulating the agricultural implement, which is controlled by the portable computer unit. The communication module can be the communication module of the wirelessly communicating module or another electronic module, which is equipped to execute an electronic communication with other electronic modules. The other external computer, which is wirelessly connected to the portable computer unit, can be for example, a server or a computer, which is connected to a network in some other way. For this purpose, the communication module has the hardware and software required for doing so. The location and/or operating data can be used for proof of work and accounting purposes as well as for the map creation for precision farming applications. The data can also be stored on user platforms, and is kept available there for further cultivation processes. For instance, manufacturers of seeds and plant protecting agents offer user platforms in order to propose optimizations on the basis of the stored data. The data for controlling and regulating the agricultural implement is data, which is of interest for internal optimization purposes or for analyses in the best practice intercompany comparison or as part of expert systems.

According to a design of the invention, the retrofitting kit is designed for the use at a plow as an agricultural implement, wherein the retrofitting kit has a sensor for capturing the actual working width of the plow and/or for capturing an angle of rotation, the sensor is connected to the portable computer unit, and the portable computer unit has a software, via which the sensor value and/or a control signal derived from the sensor value can be transmitted to the control electronics of the tractor and/or via a communication module to another external computer, which is connected via the first or second interface and/or wirelessly to the portable computer unit. So far, plows have not been equipped with electronic components, which, during ongoing operation, provide for an automated width adaptation of the plow to a lane guidance line previously planned in a lane planning system This is now possible by means of the sensor-supported capturing of the actual working width, the software-supported comparison of the actual working width to a target working width, and the likewise software-supported adaptation of the actual working width to the target working width, which takes place if deviations are determined, by means of the transmittal of corresponding control signals to the working width cylinder, which is usually controlled from the tractor. The same applies for the actual angle of rotation of the plow, which is captured by the sensor, to the ground or to the driving direction, and the adaptation of the angle of rotation to a target angle of rotation. Apart from that, an actuator can also be controlled directly at the agricultural implement, if it is possible to use said actuator to adjust the working width.

According to a design of the invention, the retrofitting kit is designed for the use at a plow as an agricultural implement, wherein the portable computer unit is designed to exchange data with another external computer, which is wirelessly connected to the portable computer unit, via a communication module, wherein the data is data for controlling and regulating the plow, which is controlled by the portable computer unit. The communication option with external computers makes it possible, for example, to transfer externally created cultivation maps to the portable computer unit and to implement said cultivation maps by means of the portable computer unit. The cultivation map can have been created on an external farm or business computer, but it is also possible to create the cultivation map on a terminal in the tractor, and to transmit it from there to the portable computer unit. The communication module can thereby be arranged in the portable computer unit itself, or the portable computer unit uses the Internet access of a smart device, which is coupled to the portable computer unit and to which the portable computer unit is connected via a wireless connection, or an Internet access on the tractor, to which the portable computer unit is connected via an ISOBUS connection. The communication option makes it possible to control the working width of plows with a variable working width control in an automated manner by observing planning specifications from a previously created cultivation map. The documentation data can likewise be transferred to the storage or further processing location via the communication module.

According to a design of the invention, the retrofitting kit is designed for the use at a grubber or a compact disc harrow as an agricultural implement, wherein the retrofitting kit has a sensor for capturing the actual working depth of the grubber or of the compact disc harrow, the sensor is connected to the portable computer unit, and the portable computer unit has a software, via which the sensor value and/or a control signal derived from the sensor value can be transmitted to the control electronics of the tractor and/or via a communication module to another external computer, which is connected via the first or second interface and/or wirelessly to the portable computer unit. The sensor provides for a current or ongoing comparison of the working depth during the grubbing to a previously planned actual value, and control variables for the height adjustment, which is implemented, for example, by the tractor, result from the comparison. If the working depth adjustment takes place via a hydraulic cylinder, which is controlled from the tractor, it is expedient to transmit the control signal for height adaptations to the tractor. Apart from that, an actuator can also be controlled directly at the agricultural implement if it is possible to use said actuator to adjust the working depth. The feature combination provides for an automatic working depth guidance for a grubber or a compact disc harrow. So far, grubbers or compact disc harrows have not been equipped with electronic components, which provide for an automated regulation of the working depth of the grubber or of the compact disc harrow during ongoing operation. This is now possible by means of the above-mentioned feature combination.

According to a design of the invention, the retrofitting kit is designed for the use at a grubber or a compact disc harrow as an agricultural implement, wherein the portable computer unit is designed to exchange data with another external computer, which is wirelessly connected to the portable computer unit, via a communication module, wherein the data is data for controlling and regulating the grubber or the compact disc harrow, which is controlled by the portable computer unit. The communication option with external computers makes it possible, for example, to transfer externally created cultivation maps to the portable computer unit and to implement said cultivation maps by means of the portable computer unit. The cultivation map can have been created on an external farm or business computer, but it is also possible to create the cultivation map on a terminal in the tractor, and to transmit it from there to the portable computer unit. The communication module can thereby be arranged in the portable computer unit itself, or the portable computer unit uses the Internet access of a smart device, to which the portable computer unit is connected via a wireless connection, or an Internet access on the tractor, to which the portable computer unit is connected via an ISOBUS connection. The communication option makes it possible to control the working depth of grubbers or compact disc harrows comprising a variable working depth control in an automated manner by observing planning specifications from a previously created cultivation map. The documentation data can likewise be transferred to the storage or further processing location via the communication module.

According to a design of the invention, the retrofitting kit is designed for the use at a seeder as an agricultural implement, wherein the retrofitting kit has a sensor for capturing the work quality of the seeder, the sensor is connected to the portable computer unit, and the portable computer unit has a software, via which the sensor value and/or a control signal derived from the sensor value can be transmitted to the control electronics of the tractor and/or via a communication module to another external computer, which is connected via the first or second interface and/or wirelessly to the portable computer unit. So far, seeders have not been equipped with electronic components, which provide for an automated assessment of the work quality of the seeder during ongoing operation. The sensor provides for a current or ongoing comparison of the quality of the seedbed preparation to a previously planned target value, and control variables for setting the parameters, which influence the seedbed preparation and which are implemented by the tractor and/or by actuators, which are arranged on the seeder and can be directly controlled there, result from the comparison. The metering of the seeds, precision of the placement, placement depth, and the recompacting are possible parameters. If the adjustment of the parameters, which are relevant for spreading the seeds, takes place via a device, which is controlled from the tractor, it is expedient to transmit the control signal for the adjustment to the tractor. Apart from that, an actuator can also be controlled directly at the agricultural implement, if it is possible to use said actuator to adjust a relevant parameter. The feature combination provides for an automatic regulation of the parameters, which are relevant for spreading the seeds. So far, seeders have not been equipped with electronic components, which provide for an automated regulation of the desired seeding quality during ongoing operation. This is now possible by means of the above-mentioned feature combination.

According to a design of the invention, the retrofitting kit is designed for the use at a seeder as an agricultural implement, wherein the portable computer unit is designed to exchange data with another external computer, which is wirelessly connected to the portable computer unit, via a communication module, wherein the data is data for controlling and regulating the seeder, which is controlled by the portable computer unit. The communication module can thereby be arranged in the portable computer unit itself, or the portable computer unit uses the Internet access of a smart device, which is coupled to the portable computer unit and to which the portable computer unit is connected via a wireless connection, or an Internet access on the tractor, to which the portable computer unit is connected via an ISOBUS connection. The communication option makes it possible to control the work quality of seeders in an automated manner by observing planning specifications from a previously created cultivation map. The documentation data can likewise be transferred to the storage or further processing location via the communication module.

According to a design of the invention, the retrofitting kit is designed for the use at a rotary harrow as an agricultural implement, wherein the retrofitting kit has a sensor for capturing the work quality of the rotary harrow, the sensor is connected to the portable computer unit, and the portable computer unit has a software, via which the sensor value and/or a control signal derived from the sensor value can be transmitted to the control electronics of the tractor and/or via a communication module to another external computer, which is connected via the first or second interface and/or wirelessly to the portable computer unit. So far, rotary harrows have not been equipped with electronic components, which provide for an automated assessment of the work quality of the rotary harrow during ongoing operation. The sensor provides for a current or ongoing comparison of the quality of the seedbed preparation of the rotary harrow to a previously planned target value, and control variables for setting the parameters, which influence the seedbed preparation by means of the rotary harrow and which are implemented by the tractor and/or by actuators, which are arranged on the rotary harrow and can be directly controlled there, result from the comparison. The speed of the power take-off shaft of the tractor, the hydraulic working depth adjustment, the hydraulic levelling bar adjustment, the forward driving speed, and the lifting gear height of the tractor, and the setting of the hydraulic upper link are possible parameters. If the adjustment of the parameters, which are relevant for the spreading of the seeds, takes place via a device, which is controlled from the tractor, it is expedient to transmit the control signal for the adjustment to the tractor. Apart from that, an actuator can also be controlled directly at the agricultural implement if it is possible to use said actuator to adjust a relevant parameter. The feature combination provides for an automatic regulation of the work quality of a rotary harrow. So far, rotary harrows have not been equipped with electronic components, which provide for an automated regulation of the work quality during ongoing operation. This is now possible by means of the above-mentioned feature combination. Planning specifications, such as, for example, a specified crumb structure, working depths, and the like, can also be implemented in an automated manner from a previously created cultivation map.

According to a design of the invention, the sensor for capturing the work quality is an optical, radar, and/or ultrasonic sensor for analyzing the crumb structure of the soil. The assessment-relevant parameters can be captured particularly well and can be evaluated in an automated manner by means of these sensor types. With the combination of various sensor types, the analysis result for capturing the work quality can be improved, compared to the use of only a single sensor type.

Further features of the invention follow from the claims, the figures, and the present description. All of the features and feature combinations mentioned above in the description, as well as the features and feature combinations mentioned below in the FIGURE description and/or shown in the figures alone, cannot only be used in the respective specified combination, but also in other combinations, or alone.

The invention will now be described in more detail on the basis of a preferred exemplary embodiment as well as with reference to the enclosed drawings, in which:

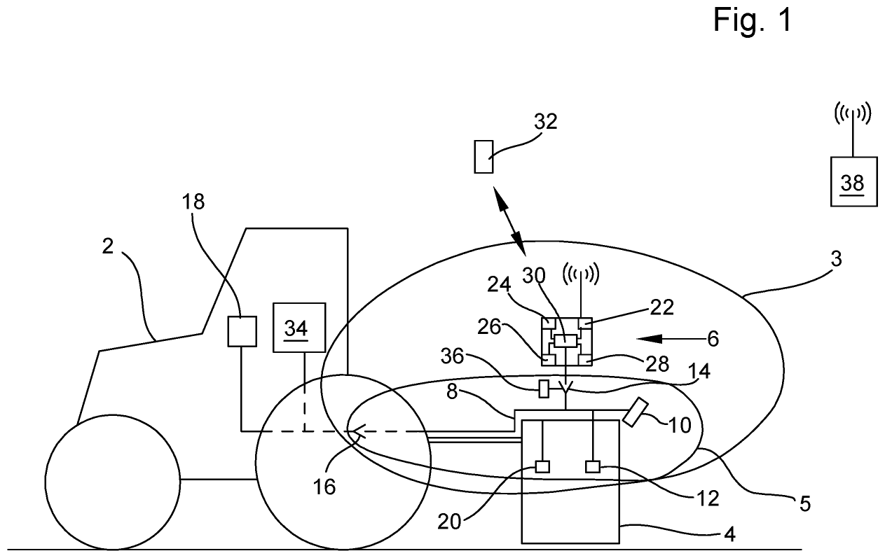

FIG. 1: shows a schematic illustration of a tractor comprising an agricultural implement and a retrofitting kit installed thereon.

FIG. 1 shows a tractor 2, to which an agricultural implement 4 is attached. The agricultural implement 4 is equipped with a retrofitting kit 3. The retrofitting kit 3 consists of a portable computer unit 6 as well as of a number of implement-specific components 5.

While the portable computer unit 6 is designed to be capable of being easily removed from the agricultural implement 4 and of being operated on changing agricultural implements 4, the implement-specific components 5 are designed to permanently remain at the respective agricultural implement 4. The implement-specific components 5 are matched exactly to the individual need in the respective agricultural implement.

The implement-specific components 5 can be, for example, a wire harness 8, a sensor 10, an actuator 12, as well a first interface 14 and/or a second interface 16. It goes without saying that the above-mentioned components can also be present in plural.

The used sensors 10 are in each case designed so as to match, in order to be able to fulfill the control purpose, for which they are installed on the agricultural implement 4. The sensors 10 can be, for example, speed, laser, or ultrasonic sensors. Cameras, which are coupled to an image evaluation software, are also possible as sensor 10. Radar sensors can also be used, in order to assess the work quality of an agricultural implement 4. Other suitable sensor types are also possible.

An actuator 12 can be, for example, an electrical switch, a hydraulic or pneumatic switch valve, a hydraulic, pneumatic, or electric motor, a hydraulic cylinder, a mechanically, hydraulically, or electrically operated coupling, a speed controller, or another component, which changes an operating state in the implement by means of a movement. An actuator 12 can have an electronic component, which converts an electrical or electronic control signal, which was output by the portable computer unit 6, into a control command, which can be implemented by the actuator 12.

The first interface 14 has one or several electrical plug connections. The plug connections preferably also serve the purpose of ensuring the power supply of the portable computer unit 6. The portable computer unit 6 can be connected via the first interface 14 to the power supply of the tractor 2, which consists of a battery placed there and/or of an alternator. Due to this power supply, the portable computer unit 6 either does not require a separate storage for electrical energy, or the electrical storage can be significantly smaller than would be necessary to operate the portable computer unit 6 for hours with the electrical energy stored in said storage.

The electrical and/or electronic plug connections include further connections for connecting the portable computer unit 6 to the implement-specific components 5. The electrical and/or electronic connections can be established via the wire harness 8, which can be designed to keep a connecting cable to the portable computer unit 6 ready for each of the available implement-specific components 5. To reduce the number of the wires contained in the wire harness 8, one or several of the electrical and/or electronic plug connections can also be a bus connection, via which a data bus communication is possible. At least one data bus connection is thus also advantageous in order to be able to communicate with the bus network in the tractor 2 via the second interface 16. The portable computer unit 6 can represent an addition to the bus network in the tractor 2, the portable computer unit 6, however, can additionally or alternatively also organize and operate a separate bus network with the implement-specific components 5.

The first interface 14 additionally also has a mechanical connection for fixing the position of the portable computer unit 6. This can be a positive mount, by means of which the portable computer unit 6 is held in the operating position. In addition to the positive connection, further mechanical securing means can be provided, in order to keep the portable computer unit in the installation position. For instance, special clips, clamps, bolts, and the like can be available there, which, on the one hand, provide for a good preferably positive position fixation, but which can also be displaced easily, in order to easily unlock the portable computer unit 6 for a removal. The locking elements can preferably be operated in a tool-free manner.

The above descriptions relating to the design of the first interface 14 also apply analogously for the second interface 16.

In the exemplary embodiment, an operating terminal 18 is arranged in the driver cab of the tractor 2. The operating terminal 18 has a graphic display as well as further operating elements, such as, for example, buttons and/or softkeys. The operating terminal 18 can also be controlled via a touch-sensitive user interface of the screen. The operating terminal 18 is connected to the bus network of the tactor 2. Via the bus network in the tractor 2, the operating terminal 18 can communicate with the portable computer unit 6 via the second interface 16 and the first interface 14. The portable computer unit 6 can thus transmit data, which is displayed to a user on the operating terminal 18, to the operating terminal 18, and vice versa, operating instructions made by a user on the operating terminal 18 can be transmitted to the portable computer unit 6. It is possible in this way for a user to operate and control the towed agricultural machine 4 by means of the communication between the portable computer unit 6 and the operating terminal 18.

The implement-specific components 5 can also have a slave module 20, which executes secondary computation, maintenance, and control functions. The slave module 20 can be organized such that it communicates with the portable computer unit 6 only if any interference states occur, or if the slave module 20 requires operating specifications, which the computer unit 6 provides.

The portable computer unit 6 can have a communication module 22, which provides for a wireless mobile communication with a radio network. The communication module 22 can be used for the purpose that the portable computer unit 6 exchanges data with external computers 38. The external computer 38 can be a farm or business computer, respectively, which the farmer or contractor can use to plan and control the machine use, as well as for precision farming applications. The data exchange can take place bidirectionally thereby, so that the portable computer unit 6 receives data from the external computer 38 as well as transmits operating data from the agricultural implement 4 to the external computer 38. However, the communication can also be organized in only one direction. The external computer can also be a range of services from the Internet. The manufacturers of the agricultural implements 4, agencies, agricultural machinery manufacturers, other service providers in the agricultural sector or subcontractors of consumable materials, such as seeds, fertilizer or plant protecting agent manufacturers, can thus be involved and interested in a data exchange. A communication with the external computers 38 of these involved parties is possible via the communication module 22.

However, a data exchange is not limited to the communication module 22. A wireless data communication can also be organized, for example, via the operating terminal 18, if the latter has a corresponding communication module 22. A data communication with an eternal computer 38 can also take place via the control electronics 34 of the tractor 2, if it has a communication module 22, or the communication module 22 or a wirelessly communicating module 26 of the portable computer unit 6 communicate with a mobile device 32 as smart device, such as, for example, a mobile phone, a tablet, or a laptop, which then have a separate communication module 22.

The portable computer unit 6 can furthermore have a positioning module 24. The positioning module 24 can determine the respective geographical position of the towed agricultural implement 4 at a desired point in time at a specified clock rate. When working with the agricultural implement 4, this is expedient in particular when georeferenced operating data is to be collected and is to be stored or transferred for evaluation purposes, or if the cultivation of the field is to take place in a positionally accurate manner and is controlled accordingly. The positioning module 22 can determine the position by means of GPS, Glonass, Galileo, or Beidou data. The accuracy of this position data can be improved further with the reception of correction signals. For this purpose, the positioning module 24 can be equipped for receiving the respective correction signals.

The equipment of the portable computer unit 6 with a wirelessly communicating module 26 is also advantageous because an app, which provides for a display of data, which the portable computer unit 6 transmits to the mobile device 32, such as, for example, status and operating data displays of the agricultural implement 4, can be installed on the mobile device 32. However, control commands can also be transmitted via the app, which is installed on the mobile device 32, to the portable computer unit 6, which the latter then converts into corresponding control commands for the implement-specific components 5 and transmits them. A control of the agricultural implement 4 is thus possible via the portable computer unit 6 and the app on the mobile device 32.

In addition, the portable computer unit 6 can communicate with the control electronics 34 of the tractor 2. Via this communication, it is possible that the portable computer unit 6 influences operating parameters of the tractor 2, such as, for example, the forward driving speed, the speed of the power take-off shaft, switch positions of hydraulic valves, the pump speed, and pressures of the hydraulic or load-sensing pump, respectively, in the tractor 2, or also electrical or electronic switches in the tractor 2. It is likewise possible that the control electronics 34 transmits data to the portable computer unit 6, which the latter evaluates, in order to optionally issue control commands to the implement-specific components 5, which are arranged downstream. Due to the communication of the portable computer unit 6 with the control electronics 34, a machine system is created, the parts of which can be operated so as to be networked with one another.

The portable computer unit 6 has a central computer 30, on which the software required for the operation of the portable computer unit 6 is stored, and on which said software can be operated. The software is in particular software, which is suitable to control the respective towed agricultural implement 4, on which the portable computer unit 6 is installed. The central computer 30 can accordingly have a plurality of software packages, which are programmed for the operation of various agricultural implements 4. The central computer 30 handles the communication with the individual implement-specific components 5, the further modules, which are available in the portable computer unit 6, comprising the external computers 38 and the operating terminal 18 or the control electronics 34, respectively, on the tractor 2 via the software stored thereon. The respective software also determines, from where data required for the operation of the agricultural implement is downloaded, or where this data is stored. The software stored on the portable computer unit 6 can also be organized such that partial routines of the software run on external computers 38, and the portable computer unit 6 only downloads selected data packages from the external computers 38, which are required for the current operation of the agricultural implement 4.

The software stored on the central computer 30 makes it possible that the portable computer unit 6 and the agricultural implement 4 are operated in an automatic mode. When the portable computer unit 6 runs in the automatic operation, it is not required that an operator manually intervenes in the operation of the portable computer unit 6 and/or of the agricultural implement 4.

The agricultural implements 4 can be, for example, a plow, a grubber, a compact disc harrow, a rotary harrow, a seeder, or some other implement for soil cultivation, stubble cultivation, the soil compacting, the sowing, the crop protection, the forage harvest, the slurry application, or some other agricultural implements.

So that the portable computer unit 6 can recognize the type of agricultural implement 4, on which it is currently mounted, it is advantageous when the first interface 14 has an identification device 36. The identification device 36 can contain information, which makes it possible for the portable computer unit 6 to adapt to the respective agricultural implement 4. The identification device 36 can thereby have additional information relating to previously selected operating parameters for setting the implement-specific components 5. It is likewise possible that information relating to the communication with external computers 38 and/or with the tractor 2 is stored in the identification device 36. Job-related data for the operation of the respective agricultural implement 4 can also already be stored in the identification device 36.

The invention is not limited to the above-described exemplary embodiment. It is not difficult for the person of skill in the art to modify the exemplary embodiment in a manner, which appears to be suitable for him, in order to adapt it to a concrete application.

1. A retrofitting kit (3) having electrical and/or electronic components to be mounted on an agricultural implement (4), which can be mounted on a tractor (2) and which can be operated in combination therewith, characterized in that the retrofitting kit (3) has implement-specific components for the permanent mounting on the agricultural implement (4), a portable computer unit (6), and a first interface (14) for the electronic connection of the implement-specific components (5) to the portable computer unit (6), which can be used as required, the portable computer unit (6) is designed to be removed from the agricultural implement 4 and to be operated on changing agricultural implements (4), wherein the implement-specific components (5) of the retrofitting kit (3) include sensors (10) for determining process-relevant data and technical transmission means, by means of which the data determined by the sensors (10) can be transmitted to the portable computer unit (6), wherein the portable computer unit (6) includes many building blocks, which are required for the electronic function help of various types of agricultural implements.

2. The retrofitting kit (3) according to claim 1, characterized in that the first interface (14) has one or several electrical and/or electronic plug connections, which connect the portable computer unit (6) in the operating position to at least one of the implement-specific components (5), and an additional mechanical connection for fixing the position of the portable computer unit (6) in the operating position additionally exists between the implement-specific components (5) and the portable computer unit (6) in the operating position.

3. The retrofitting kit (3) according to claim 1, characterized in that the implement-specific components (5) and/or the portable computer unit (6) have a second interface (16) to the control electronics (34) of the tractor (2) and/or to an operating terminal (18) arranged in the tractor cab.

4. The retrofitting kit (3) according to claim 1, characterized in that the first and/or second interface (14, 16) are formed as data bus connection, via which a data exchange with other electronic components connected to the data bus can take place.

5. (canceled)

6. The retrofitting kit (3) according to claim 1, characterized in that the implement-specific components (5) include an implement-specific wire harness (8).

7. The retrofitting kit (3) according to claim 1, characterized in that the implement-specific components (5) include an actuator (12), which can be controlled by the portable computer unit (6).

8. The retrofitting kit (3) according to claim 1, characterized in that the implement-specific components (5) include electronic slave modules (20), which can be operated in functional dependence on the portable computer unit (6).

9. The retrofitting kit (3) according to claim 1, characterized in that the first interface (14) for the electronic connection of the implement-specific components (5) to the exchangeable portable computer unit (6) has a connection for the electric voltage supply.

10. The retrofitting kit (3) according to claim 1, characterized in that the portable computer unit (6) has a communication module (22).

11. The retrofitting kit (3) according to claim 1, characterized in that the portable computer unit (6) has a positioning module (24).

12. The retrofitting kit (3) according to claim 1, characterized in that the portable computer unit (6) has a wirelessly communicating module (26).

13. The retrofitting kit (3) according to claim 1, characterized in that the portable computer unit (6) has one or several connections to a data bus network.

14. The retrofitting kit (3) according to claim 1, characterized in that the portable computer unit (6) has a separate rechargeable storage (28) for electrical energy.

15. The retrofitting kit (3) according to claim 1, characterized in that the portable computer unit (6) has a module for the communication with the tractor (2).

16. The retrofitting kit (3) according to claim 1, characterized in that the input of operating commands to the portable computer unit (6) and/or the output of information from the portable computer unit (6) to an operator takes place via an app software installed on a separate mobile device (32), and a wireless communication connection existing between the portable computer unit (6) and the separate mobile device (32) takes place on the separate mobile device (32).

17. The retrofitting kit (3) according to claim 3, characterized in that the input of operating commands to the portable computer unit (6) and/or the output of information from the portable computer unit (6) to an operator takes place via the second interface (16) to the control electronics (34) of the tractor (2) and/or to an operating terminal (18) arranged in the tractor cab.

18. The retrofitting kit (3) according to claim 1, characterized in that the first interface (14) for the electronic connection of the implement-specific components (5) to an exchangeable portable computer unit (6) has an identification device (36), by means of which the portable computer unit (6) recognizes the respective agricultural implement (4) when being connected to the first interface (14).

19. The retrofitting kit (3) according to claim 18, characterized in that the portable computer unit (6) has a control program, which starts a control software, which is stored in the portable computer unit (6) via the implement recognition and/or which is available remotely via a data connection, in order to control the recognized agricultural implement (4).

20. The retrofitting kit (3) according to claim 1, characterized in that, depending on the technical equipment and setting, the portable computer unit (6) stores data collected during the operation of the agricultural implement (4) on the portable computer unit (6) and/or transmits the collected data via a data connection to a remote computer (38).

21. The retrofitting kit (3) according to claim 1, characterized in that the portable computer unit (6) has a software, which guides the user through an operating process in a dialog system, wherein the software, in dialog with the operator, transmits relevant control commands output by the operator for the operation of the agricultural implement (4) to the control electronics (34) of the tractor (2).

22. The retrofitting kit (3) according to claim 1, characterized in that the portable computer unit (6) has a software, which can be operated in an automatic mode, wherein in the automatic mode, the software transmits control commands, which are relevant for the operation of the agricultural implement (4), to the control electronics (34) of the tractor (2).

23. The retrofitting kit (3) according to claim 1, characterized in that the portable computer unit (6) has a software, which can be operated in an automatic mode, wherein in the automatic mode, the software receives control commands, which are relevant for the operation of the agricultural implement (4), from the control electronics (34) of the tractor (2) and/or of the operating terminal (18), and transfers said control commands to the connected implement-specific components (5) for the execution thereof.

24. The retrofitting kit (3) according to claim 1, characterized in that the retrofitting kit (3) also permits an operation of the agricultural implement (4) without a portable computer unit (6), which is in the operating position.

25. The retrofitting kit (3) according to claim 1, characterized in that the portable computer unit (6) is designed to exchange data with another external computer (38), which is wirelessly connected to the portable computer unit (6), via a communication module (22, 26), wherein the data is location and/or operating data of the agricultural implement (4) and/or data for controlling and regulating the agricultural implement (4), which is controlled by the portable computer unit (6).

26. The retrofitting kit (3) according to claim 1, characterized in that the retrofitting kit (3) is designed for the use at a plow as an agricultural implement (4), wherein the retrofitting kit (3) has a sensor (10) for capturing the actual working width of the plow and/or for capturing an angle of rotation, the sensor (10) is connected to the portable computer unit (6), and the portable computer unit (6) has a software, via which the sensor value and/or a control signal derived from the sensor value can be transmitted to the control electronics (34) of the tractor (2) and/or via a communication module (22, 26) to another external computer (38), which is connected via the first or second interface (14, 16) and/or wirelessly to the portable computer unit (6).

27. The retrofitting kit (3) according to claim 1, characterized in that the retrofitting kit (3) is designed for the use at a plow as an agricultural implement (4), wherein the portable computer unit (6) is designed to exchange data with another external computer (38), which is wirelessly connected to the portable computer unit (6), via a communication module (22, 26), wherein the data is data for controlling and regulating the plow, which is controlled by the portable computer unit (6).

28. The retrofitting kit (3) according to claim 1, characterized in that the retrofitting kit (3) is designed for the use at a grubber or a compact disc harrow as an agricultural implement (4), wherein the retrofitting kit (3) has a sensor (10) for capturing the actual working depth of the grubber or of the compact disc harrow, the sensor (10) is connected to the portable computer unit (6), and the portable computer unit (6) has a software, via which the sensor value and/or a control signal derived from the sensor value can be transmitted to the control electronics (34) of the tractor (2) and/or via a communication module (22, 26) to another external computer (38), which is connected via the first or second interface (14, 16) and/or wirelessly to the portable computer unit (6).

29. The retrofitting kit (3) according to claim 1, characterized in that the retrofitting kit (3) is designed for the use at a grubber or a compact disc harrow as an agricultural implement (4), wherein the portable computer unit (6) is designed to exchange data with another external computer (38), which is wirelessly connected to the portable computer unit (6), via a communication module (22, 26), wherein the data is data for controlling and regulating the grubber or the compact disc harrow, which is controlled by the portable computer unit (6).

30. The retrofitting kit (3) according to claim 1, characterized in that the retrofitting kit (3) is designed for the use at a seeder as an agricultural implement (4), wherein the retrofitting kit (3) has a sensor (10) for capturing the work quality of the seeder, the sensor (10) is connected to the portable computer unit (6), and the portable computer unit (6) has a software, via which the sensor value and/or a control signal derived from the sensor value can be transmitted to the control electronics (34) of the tractor (2) and/or via a communication module (22, 26) to another external computer (38), which is connected via the first or second interface (14, 16) and/or wirelessly to the portable computer unit (6).

31. The retrofitting kit (3) according to claim 1, characterized in that the retrofitting kit (3) is designed for the use at a seeder as an agricultural implement (4), wherein the portable computer unit (6) is designed to exchange data with another external computer (38), which is wirelessly connected to the portable computer unit (6), via a communication module (22, 26), wherein the data is data for controlling and regulating the seeder, which is controlled by the portable computer unit (6).

32. The retrofitting kit (3) according to claim 1, characterized in that the retrofitting kit (3) is designed for the use at a rotary harrow as an agricultural implement (4), wherein the retrofitting kit (3) has a sensor (10) for capturing the work quality of the rotary harrow, the sensor (10) is connected to the portable computer unit (6), and the portable computer unit (6) has a software, via which the sensor value and/or a control signal derived from the sensor value can be transmitted to the control electronics (34) of the tractor (2) and/or via a communication module (22, 26) to another external computer (38), which is connected via the first or second interface (14, 16) and/or wirelessly to the portable computer unit (6).

33. The retrofitting kit (3) according to claim 32, characterized in that the sensor (10) for capturing the work quality is an optical, radar, and/or ultrasonic sensor for analyzing the crumb structure of the soil.
